(19) United States
(12) Patent Application Publication
(10) Pub. No.: US 2005/0136847 A1
(43) Pub. Date: Jun. 23, 2005

(54) Communication semiconductor integrated circuit device and electrical apparatus

(76) Inventors: Hiroaki Matsui, Takasaki (JP); Taizo Yamawaki, Shibuya (JP); Masahiro Ito, Kokubunji (JP); Masakatsu Yokota, Takasaki (JP)

Correspondence Address: Mattingly, Stanger & Malur, P.C.;Suite 370, 1800 Diagonal Road, Alexandria, VA, 22314, US

(21) Appl. No.: 11/011,153

(22) Filed: Dec. 15, 2004

(30) Foreign Application Priority Data
Dec. 19, 2003 (JP) 2003-421726

(51) Int. Cl. H04B 1/44

(52) U.S. Cl. 455/78; 455/81

(57) ABSTRACT

A communication semiconductor integrated circuit (high frequency IC) that has a function of differentially-singly converts and outputs a transmitted signal suppressing deterioration of a harmonic suppression characteristic and enables miniaturization and an electronic component (high frequency module) that mounts the communication semiconductor integrated circuit are provided. In the communication semiconductor integrated circuit (high frequency IC) having a limiter that amplifies a modulated and up-converted transmitted signal and supplies a power amplifier with the signal, an unbalanced reduction means having, for example, differential MOS transistors is provided in collectors or drains of differential transistors that construct the limiter to output pins and continue to apply a current to the output pins and reduces the impedance of the transistor on an off side even when one of the transistors enters an off state in accordance with an input signal in parallel to the transistor.

### CROSS-REFERENCE TO RELATED APPLICATION

The present application claims priority from Japanese patent application No. 2003-421726 filed on Dec. 19, 2003, the content of which is hereby incorporated by reference into this application.

### BACKGROUND OF THE INVENTION

The present invention relates to effective technology for applying to a transmitting circuit and an output circuit of a transmitted signal in a communication semiconductor integrated circuit (high frequency IC) that constructs a radio communication system. In particular, the present invention relates to effective technology for utilization for a communication semiconductor integrated circuit that incorporates a circuit from which a transmitted and received signal is frequency-converted, amplified, and output in a cellular phone and an electronic component (module) that mounts the communication semiconductor integrated circuit.

A cellular phone of recent years usually has a baseband unit (baseband IC), a high frequency module, a power module, and a front-end module. The baseband unit performs baseband processing that converts an aural signal or a data signal to be sent into an I signal of an in-phase component and a Q signal of an orthogonal component with respect to a fundamental wave, and converts the demodulated received I and Q signals to the aural signal or the data signal. The high frequency module includes a high frequency IC or a filter, and an impedance matching circuit that perform quadrature demodulation or up-conversion with regard to the I and Q signals from the baseband unit and perform down-conversion or the quadrature demodulation with respect to a received signal. The power module includes a power amplifier that amplifies a transmitted signal by power and outputs the transmitted signal from an antenna or the impedance matching circuit. The front-end module includes a transmitter and receiver change-over switch.

Moreover, the practical use of a module that incorporates a transmission power amplifier in a front-end module is also advancing. However, a baseband unit mainly performs digital signal processing. To prevent the effects of an undesired wave or interference onto a high frequency unit, it is anticipated that the baseband unit and the high frequency unit will adopt the form of a separate chip or module in future. Incidentally, because a cellular phone is high in a request for compactness and weight reduction, the miniaturization of each of the aforementioned modules is important.

On the other hand, a conventionally proposed cellular phone includes, for example, the cellular phone of a dual band method that handles a signal of two frequency bands, such as a GSM (global system for mobile communication) of a 900-MHz band and a DCS (digital cellular system) of a 1,800-MHz band. Furthermore, in recent years, in addition to the GSM or DCS, there is a request for the cellular phone of a quad band system that handles a signal of the GSM of an 850-MHz band or a PCS (personal communication system) of a 1,900-MHz band, for example. Accordingly, a one-chip high frequency IC or a one-module high frequency electronic component used for the cellular phone that can respond to plural bands are also being developed.

In a high frequency module for constructing a cellular phone that can respond to these plural bands, the reduction in the number of components or the miniaturization of a component itself is important to miniaturize the module.

[Patent Document 1] Japanese Unexamined Patent Publication No. Hei 12 (2000)-151310 (Corresponding to U.S. Pat. No. 6,172,567).

### SUMMARY OF THE INVENTION

The transmission output of a high frequency IC requests an output level of about 0 to +5 dBm to efficiently operate a power amplifier connected to the rear stage. Moreover, with regard to the transmission output, a characteristic such as a transmission spectrum or a spurious (undesired wave) is determined depending on standards. Accordingly, to reduce interference from another circuit, the transmitted signal of the high frequency IC is frequently output as a signal of a differential format.

On the other hand, a conventional power amplifier is generally constructed as single input. Accordingly, a power amplifier is offered in which a differential-single conversion circuit called a balun having a capacitor and an inductor is provided between the output of a high frequency IC and the input of the power amplifier. Because the balun is excellent in a harmonic suppression characteristic, an SAW filter becomes unnecessary by using the balun, thereby also being advantageous to miniaturization. However, the balun offered at present is smaller in an area, but taller in height than the SAW filter. When this balun is mounted in a high frequency module, the volume of the module becomes large on the contrary. Consequently, there is a possibility of making a cellular phone difficult in miniaturization.

Thereupon, the inventors examined a circuit shown in FIG. 10 as a limiter that amplified and outputted a transmitted signal without using a balun. The circuit of FIG. 10 is an amplifier that connects a resonance circuit 12 having inductors L1 and L2 and a capacitor C1 to the collector side of a differential circuit 11 of an open collector having bipolar transistors Q1 and Q2 and a current source I0 as a load. The output on one side of this amplifier is issued as a single, that is, a single phase signal through an impedance matching circuit 13 having an inductor L3 and a capacitor C2.

An input/output characteristic in which such an amplifier is operated as a limiter is shown in FIG. 2 by a one-dot dashed line D. It is known from FIG. 2 that a C/N ratio (carrier-to-noise ratio) is excellent because the limiter of FIG. 10 is steep in a change of an output current to an input voltage, and amplitude noise can be removed by an amplitude limiting operation.

However, when one of the transistors of the differential circuit 11 completely enters an off state and a current flows only into one side of differential output, the output impedance of the resonance type load circuit 12 becomes unbalanced. As shown in FIG. 3, in addition to a harmonic wave of an odd-numbered order, such as the third or fifth harmonic wave, the harmonic wave of an even-numbered order such as the second or fourth harmonic wave is included in the output. Thus, it has become clear that there is a failure indicating that a harmonic suppression characteristic deteriorates. Further, in the circuit of FIG. 10, the impedance matching circuit 13 and the rear-stage balun shown in FIG. 9 are provided. Subsequently, a signal is picked out from the current combiner 12 differentially instead of singly, and converted differentially-singly by the balun. In this composition, the levels of the second harmonic wave and the fourth harmonic wave in FIG. 3 can be suppressed to almost “0”.

An object of this invention is to provide a communication semiconductor integrated circuit (high frequency IC) that has a function that differentially-singly converts and outputs a transmitted signal and enables miniaturization, and an electronic component (high frequency module) that mounts the communication semiconductor integrated circuit.

Another object of this invention is to provide a communication semiconductor integrated circuit that has a function that differentially-singly converts and outputs a transmitted signal and enables miniaturization suppressing the deterioration of a harmonic suppression characteristic, and a high performance electronic component that mounts the circuit.

A further object of this invention is to provide a communication semiconductor integrated circuit that enables system miniaturization and is of a high-end function and a high general-purpose use, and an electronic component that mounts the circuit.

The above and other objects, and new characteristics of this invention will become apparent from the description of this specification and accompanying drawings.

An outline of a typical invention among the inventions disclosed in this application is described below.

That is, in a communication semiconductor integrated circuit (high frequency IC) having a limiter that amplifies a modulated and up-converted transmitted signal and supplies a power amplifier with the signal, collectors or drains of differential transistors that construct the limiter are connected to output pins and formed as open collectors or open drains. An unbalanced reduction means that continues to apply a current to the output pins or reduces the impedance of the transistor on the off side is provided in parallel to the transistor even when one of the transistors enters an off state in accordance with an input signal. Here, for example, when the differential transistors are bipolar transistors as the unbalanced reduction means, MOS transistors connected in parallel to the transistors are supposed.

According to the aforementioned means, a resonance type load circuit is connected to an output pin to which a differential transistor that constructs a limiter is connected outside a chip. Subsequently, even if a transmitted signal is converted differentially-singly without using a balun, a communication electronic component (high frequency module) that can amplify and output the transmitted signal suppressing the deterioration of a harmonic suppression characteristic can be implemented.

Moreover, a gain controllable amplifier circuit is provided in parallel to the aforementioned limiter. Accordingly, when a signal whose phase is modulated, such as a GMSK modulation, is amplified and output, a transmitted signal having an excellent C/N ratio can be output by operating the limiter. Further, when a signal whose phase and amplitude are modulated such as an EDGE modulation is amplified and output, the transmitted signal can be amplified and output up to a desired level by operating the gain controllable amplifier circuit. As a result, a high frequency IC and a high frequency module of a high-end function and a high general-purpose use that match plural modulation methods can be implemented.

Effects obtained from a typical invention among the inventions disclosed in this application are described briefly below.

That is, according to the present invention, a communication semiconductor integrated circuit (high frequency IC) that can differentially-singly convert a transmitted signal without using a balun of high volume can be implemented. Accordingly, the miniaturization of a communication electronic component (high frequency module) that mounts the high frequency IC can be achieved, and, furthermore, a system of a cellular phone that uses the module can be miniaturized.

Moreover, because a communication semiconductor integrated circuit (high frequency IC) that can amplify and output a transmitted signal as a single signal suppressing the deterioration of a harmonic suppression characteristic can be implemented even without using a balun, a compact and high performance communication component (high frequency module) can be implemented.

Furthermore, according to the present invention, a communication semiconductor integrated circuit (high frequency IC) and a communication electronic component (high frequency module) of a high-end function and a high general-purpose use that can respond to plural communication methods can be implemented.

### BRIEF DESCRIPTION OF THE DRAWINGS

Preferred embodiments of the present invention will be described in detail based on the followings, wherein:

FIG. 1 is a circuit block diagram of an embodiment of a limiter suitable for applying to a circuit that amplifies a transmitted signal and outputs the signal from a post-modulation power amplifier in a high frequency module used for a radio communication system, such as a cellular phone;

FIG. 2 is a graph showing an input/output characteristic in the limiter of an embodiment and the limiter having only a differential bipolar transistor;

FIG. 3 is a graph showing a level of a harmonic component contained in output in the limiter having only the differential bipolar transistor that uses a current combiner in a load circuit;

FIG. 4 is a graph showing the level of the harmonic component contained in the output in the limiter of the embodiment;

FIG. 5 is a block diagram showing a composition example of a high frequency IC and the high frequency module that uses the high frequency IC, and the radio communication system to which the limiter of the embodiment applies;

FIG. 6 is a circuit diagram showing another embodiment of the limiter in the high frequency IC of the present invention;

FIG. 7 is a characteristic diagram showing an output level of a variable gain amplifier;

FIG. 8 is a circuit diagram showing a further embodiment of the limiter in the high frequency IC of the present invention;

FIG. 9 is a circuit diagram showing a modification example of the limiter in the high frequency of the present invention; and

FIG. 10 is a circuit diagram showing the composition of the limiter examined prior to the present invention.

### DETAILED DESCRIPTION OF THE PREFERRED EMBODIMENTS

The ideal embodiments of the present invention are described below with reference to drawings.

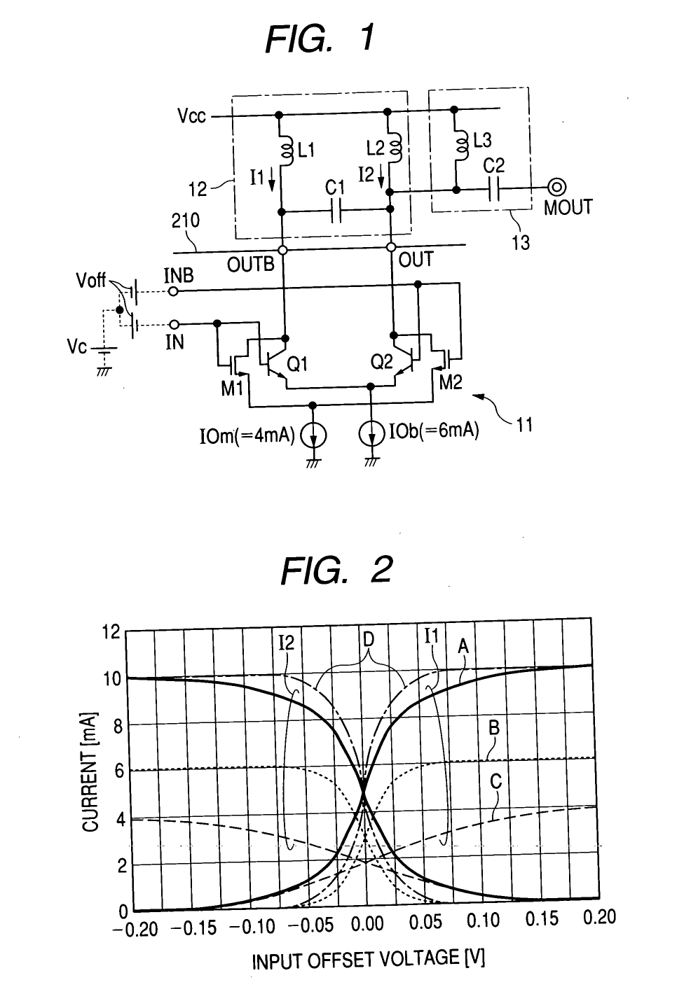

FIG. 1 shows a circuit composition example of a limiter suitable for applying to a circuit that outputs a post-modulation transmitted signal in a high frequency IC used for a radio communication system such as a cellular phone.

The limiter of this embodiment forms a differential circuit 11 in a semiconductor chip 210. The differential circuit 11 has differential bipolar transistors Q1 and Q2 with which fellow emitters are coupled and a constant current source 10b connected between the common emitter and ground point of the differential bipolar transistors Q1 and Q2. The differential circuit 11 has differential MOS transistors M1 and M2 in which drain pins are connected to the collector pins of the differential bipolar transistors Q1 and Q2 and with which mutual fellow source pins are coupled and a constant current source I0m connected between the common source and ground point of the MOS transistors M1 and M2. The differential bipolar transistor Q1 and the differential MOS transistor M1 couple the Q1 collector pin and the M1 drain pin and are connected to an external output pin OUTB of the chip respectively. Moreover, the differential bipolar transistor Q2 and the differential MOS transistor M2 couple the Q2 collector pin and the M2 drain pin and are connected to an output pin OUT of the chip respectively in the same manner.

Inductors L1 and L2 are connected to the aforementioned external output pins OUTB and OUT between the inductors and a power voltage pin Vcc respectively, and a capacitor C1 is connected between the external output pins OUTB and OUT. A resonance type load circuit (hereinafter referred to as a current combiner) 12 has the inductors L1 and L2 and the capacitor C1. Further, at the rear stage of this current combiner 12, an impedance matching circuit 13 is provided. The impedance matching circuit 13 includes an inductor L3 connected between the external output pin OUT and the power voltage pin Vcc, and a capacitor C2 connected between the external output pin OUT and an output pin MOUT of a module. A signal on the side of the external output pin OUT of the chip is picked out outside the module as the single output of the limiter. In other words, a differential-single conversion circuit is constructed by the current combiner 12.

Because the limiter of this embodiment uses a current combiner that is a resonance type load instead of a resistive load in a general differential amplifier circuit as a load circuit, the limiter can fluctuate output centering around the power voltage pin Vcc. Accordingly, as an advantage, the amplitude center is raised and an amplitude level can be increased in comparison with the case where the resistive load is used. Further, in a resonance circuit having the inductors L1 and L2 and the capacitor C1, the value of each device is selected so that the resonance point can match the frequency of a signal to be sent.

The aforementioned inductors L1, L2, and L3 and capacitors C1 and C2 have, in this embodiment, respective discrete components, and these components are electrically connected using a wiring pattern formed on a module substrate. The impedance matching circuit 13 need not always be provided in the module, and may also be constructed using a device provided outside the module. Moreover, the impedance matching circuit 13 can also be constructed using only the capacitor C2. In this embodiment, the capacitor C2 connected between the external output pin OUT of a semiconductor chip and the output pin MOUT of the module functions also as a capacitor that cuts off a DC component of output. Furthermore, the inductors L1, L2, and L3 and capacitors C1 and C2 that construct the current combiner 12 and the impedance matching circuit 13 may also be constructed using a pattern having a conductive material formed on the surface and in a module substrate, not a discrete component.

The constant current sources 10b and I0m of the differential circuit 11 are set so that the total current ratio satisfies a ratio of 6 mA to 4 mA when the total current is 10 mA, for example. Furthermore, the ratio of this current is an example to the end, and can be set optionally in accordance with a characteristic requested by a limiter.

Next, the characteristic of the limiter of this embodiment is described.

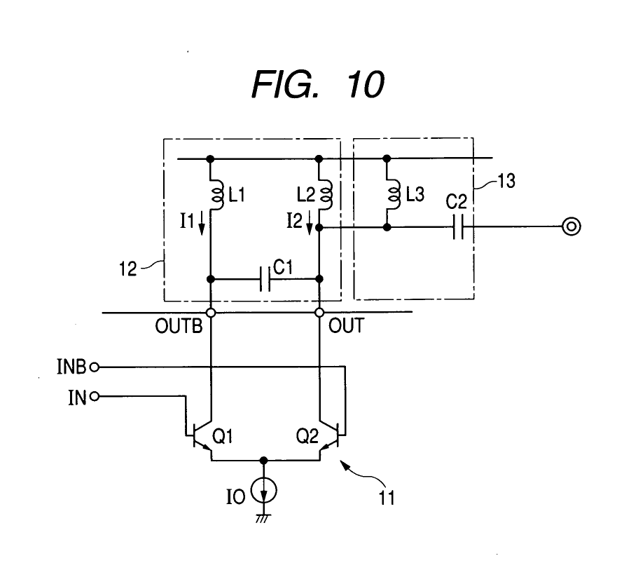

FIG. 2 shows a state of the changes in currents 11 and 12 applied to the inductors L1 and L2 when an input offset voltage Voff is assigned between input pins IN and INB of the limiter of this embodiment and changed. In FIG. 2, a dotted line B shows the changes of the input offset voltage Voff and the currents I1 and I2 by the differential bipolar transistors Q1 and Q2. A broken line C shows the changes of the input offset voltage Voff and the currents 11 and 12 by the differential MOS transistors M1 and M2. Furthermore, a solid line A shows the changes of the currents I1 and I2 by both the differential bipolar transistors Q1 and Q2 and the differential MOS transistors M1 and M2, that is, the change of the current to which the dotted line B and the broken line C are added. Further, a one-dot dashed line D shows the changes of the output currents 11 and 12. At this opportunity, in the limiter of this embodiment, the current of the constant current source 10b is set to 10 mA and the current of the constant current source I0m is set to 0 mA. In other words, in the limiter having only the bipolar transistor as shown in FIG. 10, the current 10 mA that is equal to the total current of the constant current sources 10b and I0m applies.

From FIG. 2, the limiter having only the bipolar transistor is steep in the changes of the output currents 11 and 12 with respect to the change of the input offset voltage Voff and excellent in a C/N characteristic. However, an input dynamic range, that is, the range of the input offset voltage Voff at which the output currents I1 and I2 change becomes wider in the limiter of this embodiment that uses both the bipolar transistors Q1 and Q2 and the differential MOS transistors M1 and M2.

In other words, in the case of a limiter having only the differential bipolar transistors Q1 and Q2, when the input offset voltage Voff exceeds ±0.075 V, the current on one side is set to “0”. In the case of the limiter of this embodiment, however, it is known that both the currents flow until the input offset voltage Voff arrives at ±0.15 mV. Accordingly, in comparison with the limiter having only the differential bipolar transistor, the limiter of this embodiment becomes shorter in a period during which an output current on one side does not flow. The deterioration of a harmonic suppression characteristic in the case where a differentially-singly converted signal is picked out can be reduced using a resonance type current combiner as a load without using a balun.

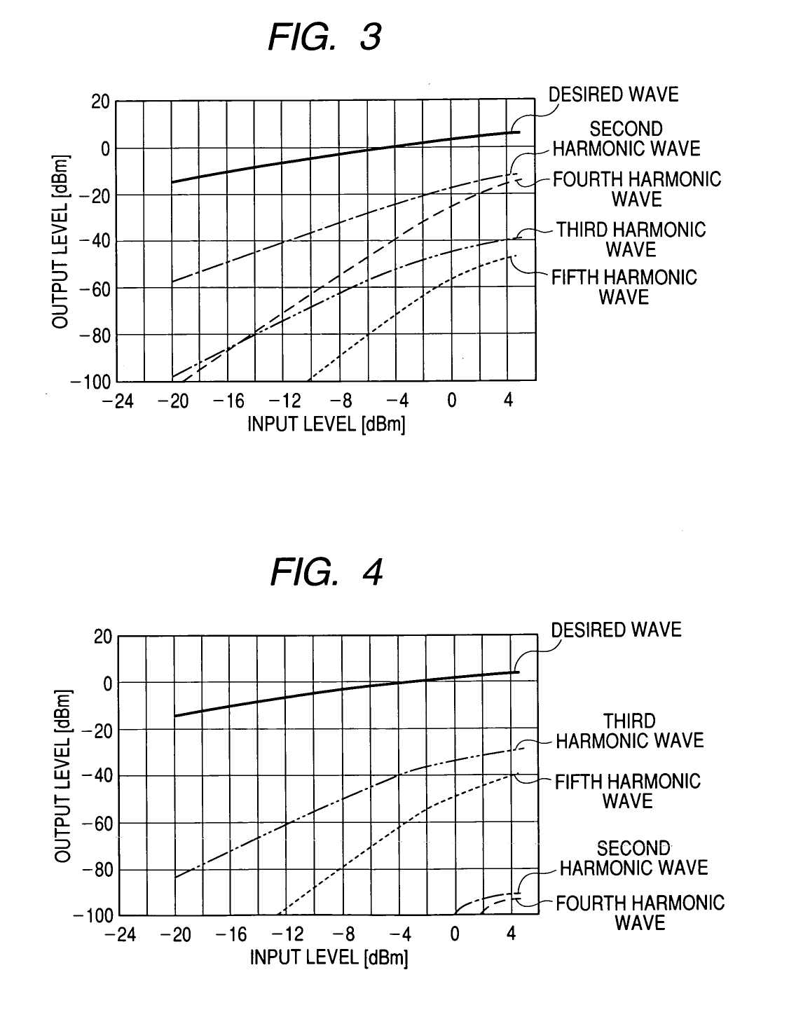

FIG. 4 shows a desired wave and a level of a harmonic component contained in the output of the limiter of this embodiment. In comparison with FIG. 3 that shows the level of the harmonic component in the limiter of FIG. 10 that does not use an MOS transistor, it is known that the levels of the second harmonic wave and the fourth harmonic wave contained in the output of the limiter of this embodiment can be reduced drastically.

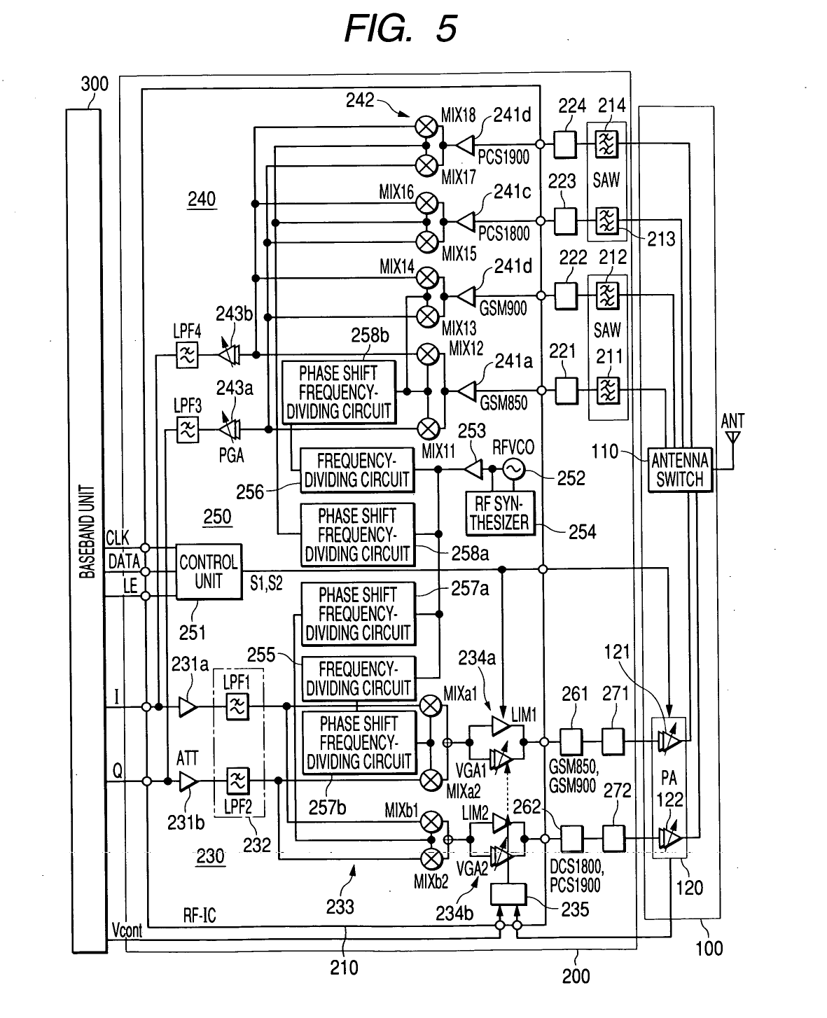

FIG. 5 is a block diagram showing a composition example of a communication semiconductor integrated circuit (high frequency IC) having the limiter of the aforementioned embodiment and an electronic component (high frequency module) that mounts the circuit, and a radio communication system that uses the electronic component. Further, in this specification, a device constructed as if it were handled as one electronic component is referred to as a module. In the specification, plural semiconductor chips and discrete components are mounted on an insulating substrate such as a ceramic substrate, in which printed wiring applies on the surface and in the inside and each component is coupled with the aforementioned printed wiring or a bonding wire so as to fulfill a predetermined function.

The radio communication system of FIG. 5 has a front-end module 100 and a high frequency module (hereinafter referred to as an RF module) 200. The front-end module 100 includes an antenna ANT that sends and receives a signal radio wave, a switch 110 that switches transmission and reception, and a high frequency power amplifier (power amplifier) 120 that amplifies a transmitted signal for power and outputs from an antenna. The high frequency module 200 mounts devices that construct high frequency filters 211 to 214 having an SAW filter that removes an undesired wave from a received signal, impedance matching circuits 221 to 224, a high frequency IC 210 that demodulates and down-converts the received signal and modulates and up-converts the transmitted signal, the aforementioned current combiners 261 and 262 or impedance matching circuits 271 and 272.

Although limited in particular, the high frequency IC 210 of this embodiment enables the modulation and demodulation of a signal according to the GSM 850, GSM 900, DCS 1800, and PCS 1900 communication methods. Moreover, in accordance of this composition, the radio communication system of this embodiment provides the SAW filters 211 and 212 that pass through the received signal of a GSM frequency band, the SAW filter 213 that passes through the received signal of a DCS 1800 frequency band, and the SAW filter 214 that passes through the received signal of a PCS 1900 frequency band.

In this embodiment, the high frequency IC 210 is constructed on one semiconductor chip as a semiconductor integrated circuit, and couples an insulating substrate that constructs a module with a bonding wire to the printed wiring formed on the surface. The capacitance device or inductance device that constructs the SAW filters 211 to 214 and the current combiners 261 and 262 uses a discrete component, and is mounted on the insulating substrate, such as a ceramic substrate, by soldering.

The impedance matching circuits 221 to 224, 271, and 272 can also be constructed using a discrete component, and can be constructed using a capacitance device connected among a transmission line (printed wiring), the predetermined place of the transmission line, and a ground point. Moreover, the capacitance device can be constructed using an interpolated capacitor in which a conductor layer formed on the front and back of any dielectric plate is used as an electrode when a substrate forms a plural-layered structure in which plural dielectric plates are laminated. The current combiners 261 and 262 can also be constructed using a wiring pattern formed on a module substrate. Instead of providing the impedance matching circuits 271 and 272 on the module substrate, an impedance matching circuit having a discrete component (inductor or capacitor) can also be provided between the RF module 200 and the front-end module 100 on a printed wiring board in which the RF module 200 or the front-end module 100 is mounted.

The high frequency IC 210 of this embodiment is roughly divided into a transmitting circuit 230, a receiving circuit 240, and a control-system circuit 250 that is common to the transmitting and receiving circuits. Although limited in particular, the transmitting circuit 230 of the high frequency IC 210 of this embodiment is a circuit of a direct up-conversion method that up-converts a transmitted signal of a voice frequency band into a signal of the transmission frequency of a direct final carrier. The receiving circuit 240 also uses a circuit of a direct down-conversion method that down-converts a received signal into the signal of the direct voice frequency band.

The control-system circuit 250 includes a control circuit 251 that generates a control signal in a chip or a local oscillation circuit 252. The control-system circuit includes an RF synthesizer 254 that constructs a PLL circuit together with the local oscillation circuit 252, a limiter amplifier 253, frequency-dividing circuits 255 and 256, and phase shift frequency-dividing circuits 257a, 257b, 258a, and 258b that generate a signal whose phase is shifted by 90°. The local oscillation circuit 252 has a VCO (voltage-controlled oscillation circuit) that can generate an oscillation signal of 3,296 to 3,820 MHz required for transmission and an oscillation signal φRF of 3,476 to 3,980 MHz required for reception, and is provided as a circuit common to the transmitting and receiving circuits.

The transmitting circuit 230 has a filter unit 232, a modulation & frequency conversion unit 233, and a gain control circuit 235. The filter unit 232 includes input circuits 231a and 231b having an attenuator that attenuates or an amplifier that amplifies an I signal and a Q signal supplied from a baseband circuit 300 respectively, and low pass filters LPF1 and LPF2 that remove a harmonic component from the attenuated or amplified I signal and Q signal. The modulation & frequency conversion unit 233 includes mixers MIXa1, MIXa2, MIXb1, and MIXb2 that simultaneously perform quadrature modulation and up-conversion by combining the filtered I signal and Q signal and orthogonal signals whose phase differs by 90° mutually from the frequency-dividing circuit 255 and the phase shift frequency-dividing circuits 257a and 257b. The gain control circuit 235 controls the gain of the amplification units 234a and 234b supplied from the amplification units 234a and 234b that amplify and output the modulated signal and the baseband circuit 300, an output level control signal Vcont, and an output detection signal Vdet supplied from the power amplifier 120.

The low pass filters LPF1 and LPF2 are provided to remove distortion (a harmonic component) or out-of-band noise generated when the I signal and Q signal pass through the input circuits 231a and 231b. Desirably, a high order filter of a second or higher filter should be used. The modulation & frequency conversion unit 233 can also share mixers by a GMS, DCS, and PCS. The high frequency IC 210 of this embodiment provides the mixers MIXa1 and MIXa2 for the GSM 850 and GSM 900 and the mixers MIXb1 and MIXb2 for the DCS 1800 and PCS 1900 separately. By providing the mixers separately, the circuit design of the mixers is facilitated and a characteristic suitable for a signal of each frequency band can be assigned, thereby enabling modulation with higher accuracy.

The amplification units 234a and 234b at the rear stage of the modulation & frequency conversion unit 233 provide limiter amplifiers LIM1 and LIM2 having a limiter function for the GSM mode that perform the GMSK modulation and gain variable amplifiers VGA1 and VGA2 for the EDGE mode that perform the 8-PSK modulation. Among these amplifiers, the limiter amplifier LIM1 and the gain variable amplifier VGA1 are provided corresponding to the mixers MIXa1 and MIXa2 for the GSM 850 and GSM 900, and the limiter amplifier LIM2 and the gain variable amplifier VGA2 are provided corresponding to the mixers MIXb1 and MIXb2 for the DCS 1800 and PCS 1900.

Whether any of the mixers MIXa1 and MIXa2, and MIXb1 and MIXb2 is to be selected, and whether any of the limiter amplifiers LIM1 and LIM2, and the gain variable amplifiers VGA1 and VGA2 is to be selected are specified with a control signal S1 that indicates a selected band and a control signal S2 that indicates a selected mode output from the control circuit 251 in accordance with a command from the baseband LSI 300. Specifically, in the case of the transmission of the GSM 850 and GMM 900 methods, the mixers MIXa1 and MIXa2 are selected with the control signal S1. In the case of the transmission of the DCS and PSC methods, the mixers MIXa1 and MIXb2 are selected. Moreover, in the transmission of the GMSK modulation mode that is a phase modulation, the limiter amplifiers LIM1 and LIM2 are selected with the control signal S2. In the transmission of the 8-PSK modulation mode accompanying the phase modulation and amplitude modulation, the gain variable amplifiers GA1 and VGA2 are selected. Although limited in particular, these control signals S1 and S2 are supplied to the front-end module 100 as well, and also used for setting a bias point of the power amplifier 120.

Moreover, a control voltage Vcont that controls the gain of the gain variable amplifiers VGA1 and VGA2 is supplied from the baseband circuit 300 to the gain control circuit 235 of the high frequency IC 210. The GSM standard defines that the output power of a transmitted signal must be held in a predetermined time mask. A radio communication system of a conventional GSM method performs an increase and a decrease in an output level inside the time mask by controlling the gain of a power amplifier 120 in general. This is implemented by controlling the gain of the gain variable amplifiers VGA1 and VGA2 using the control voltage Vcont in the radio communication system of this embodiment. The increase and decrease in the output level may also be performed by supplying both the power amplifier 120 and the gain variable amplifiers VGA1 and VGA2 with the control voltage Vcont and controlling these gains simultaneously.

Further, the high frequency IC 210 of this embodiment provides a register in the control circuit 251. This register performs a setting based on a signal from the baseband circuit 300. Specifically, a synchronizing clock signal CLK, a data signal DATA, and a load enable signal LE as a control signal are supplied from the baseband circuit 300 to the high frequency IC 210. When the control circuit 251 asserts that the load enable signal LE is in a valid level, the control circuit sequentially fetches data signal DATA transmitted from the baseband circuit 300 synchronizing with the clock signal CLK and sets the data in the register. Although limited, the data signal DATA is transmitted in serial transmission. This register includes a control register that holds a command code and a data register that holds a setting value for specifying a mode or a band.

The receiving circuit 240 has a demodulation & frequency conversion unit 242 including low noise amplifiers 241a, 241b, 241c, and 241d that amplify received signals of the GSM 850 and 900, DCS, and PCS frequency bands respectively and mixer circuits MIX11 to MIX18 that perform demodulation and down-conversion by mixing orthogonal signals generated in the frequency-dividing circuit 255 and the phase shift circuit 258a and 258b with the received signals amplified by the low noise amplifiers. The receiving circuit 240 has high gain amplifier circuits 243a and 234b that amplify the demodulated I and Q signals respectively and output the signals from the baseband circuit 300, and low pass filters LPF3 and LPF4 that remove an undesired wave from the amplified signals.

### Embodiment 2

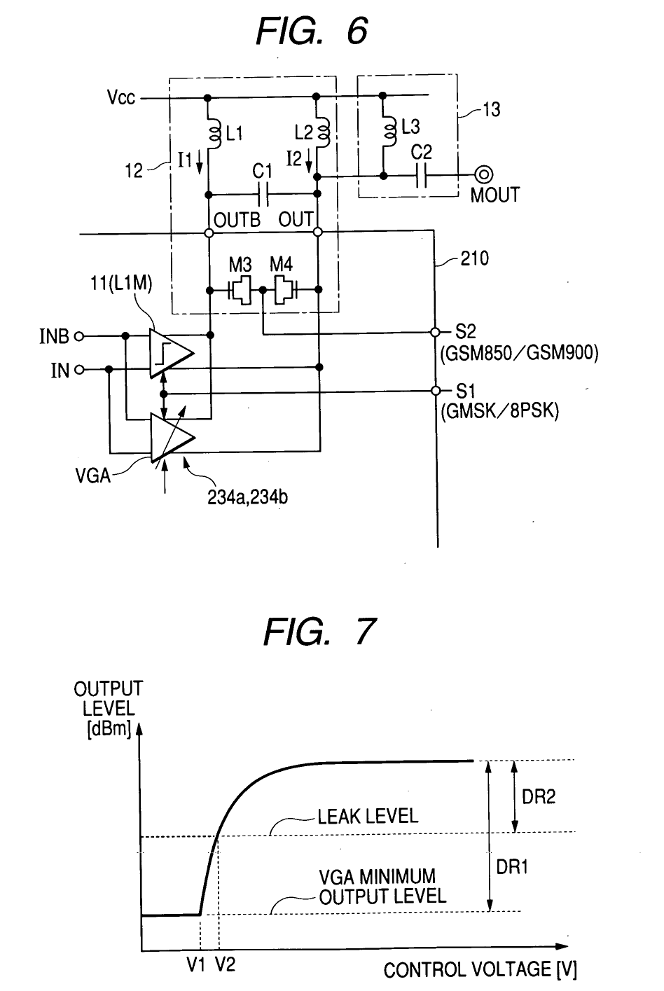

FIG. 6 shows a composition example of the load circuits of the limiters LIM1 and LIM2 and the variable gain amplifiers VGA1 and VGA2 that are suitable for utilization for the amplification units 234a and 234b of the high frequency IC 210 of the aforementioned example. In the example, a signal can be modulated and demodulated according to the GSM 850 or GMS 900 and DCS 1800 or PCS 1900 communication methods.

As shown in FIG. 6, in this embodiment, a variable capacitance device Cv is connected between the external output pins OUT and OUTB of a semiconductor chip. A capacitance value of the variable capacitance device Cv is switched with the control signal S2 that specifies a using band supplied from the baseband circuit 300, and can match a resonance point of the resonance type load circuit 12 with the frequency of a signal to be sent.

As a variable capacitance device Cv, for example, the parasitic capacitor between a gate electrode and a substrate in which a gate insulating film of an MOS transistor is used as a dielectric can be utilized. As shown in FIG. 6, the gate pins of MOS transistors M3 and M4 are connected to output the pins OUTB and OUT respectively, and source pins and drain pins are coupled and interconnected. Accordingly, a control signal S2 can be impressed. According to such composition, the control signal S2 is set at a high level (exceeding a threshold voltage of the MOS transistor), and set at a low level (below Vth). In both cases, an inversion layer is not formed in a channel of the MOS transistor, and a parasitic capacitance value varies. As a result, a resonance frequency varies. The variable capacitance device Cv is not limited to the device that utilizes the parasitic capacitor between the gate electrode and substrate of the MOS transistor. For example, two capacitance devices having a mutually different capacitance value and a change-over switch that can connect these devices between the output pins OUTB and OUT selectively may be provided, and one of the capacitance devices can also be selected and connected.

### Embodiment 3

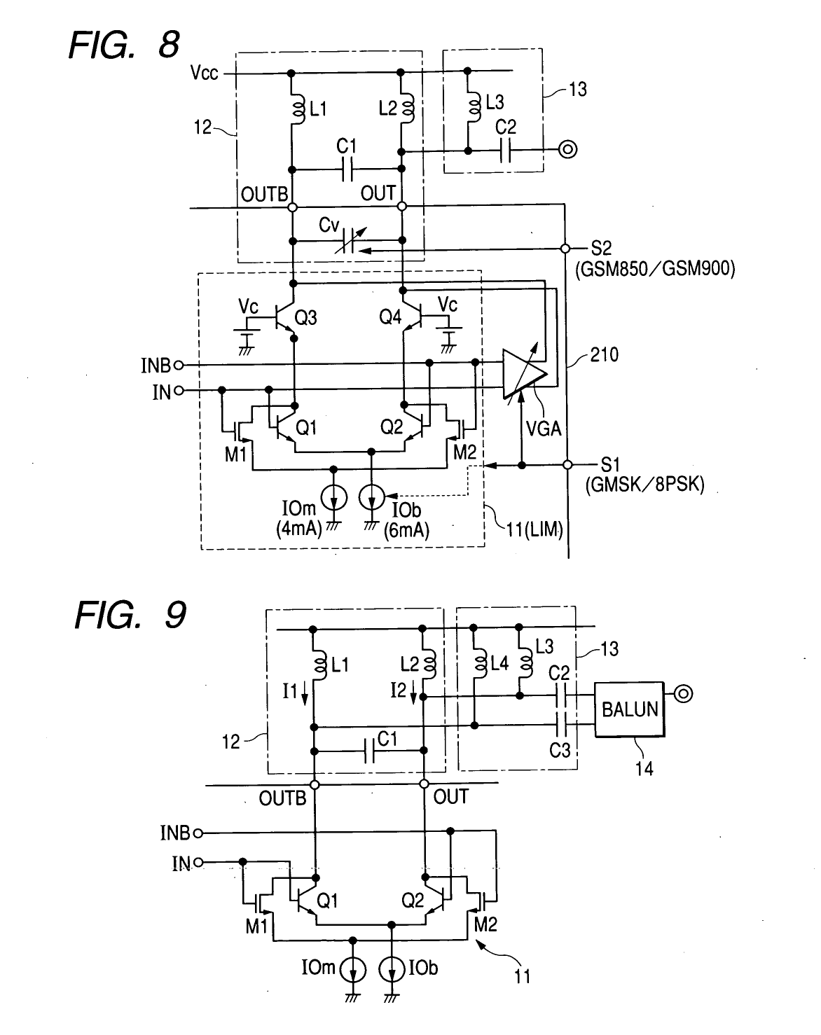

FIG. 8 shows another composition example of a limiter suitable for being utilized for the amplification units 234a and 234b of the high frequency IC 210 of the aforementioned embodiment.

In the high frequency IC 210 of the embodiment of FIG. 5, the circuit of the composition shown in FIG. 1 is used as a limiter that constructs the amplification units 234a and 234b. In this case, a control signal S1 is used in PSK modulation mode to turn on the variable gain amplifiers VGA1 and VGA2 and turn off the constant current sources I0b and I0m of the limiters LIM1 and LIM2. Consequently, even if the operation of the limiter is stopped, an input signal is leaked to the output pins OUTB and OUT through the base-collector parasitic capacitors of the differential bipolar transistors Q1 and Q2 or the gate-drain parasitic capacitors of the MOS transistors M1 and M2. As shown in FIG. 7, there is a possibility of the output dynamic ranges of the variable gain amplifiers VGA1 and VGA2 being narrowed from an original range “DR1” to “DR2” that is reduced by the extent of a leak level.

The limiter of the embodiment of FIG. 8 connects cascode transistors Q3 and Q4 between the input differential transistors Q1 and Q2 and the output pins OUTB and OUT in series, and a constant voltage Vc is applied to the base. By providing the cascode transistors Q3 and Q4, even if the collector potential of the differential bipolar transistors Q1 and Q2 or the drain potential of the MOS transistors M1 and M2 fluctuates due to a change in an input signal, the fluctuation is not transferred to the collectors of the cascode transistors Q3 and Q4. Consequently, the output dynamic range of the variable gain amplifier VGA will not be narrowed.

An invention performed by the inventors was specifically described above based on embodiments. The present invention is not limited to the embodiments, but, needless to say, the present invention can be modified variously in the range where the invention will not depart from the purpose. For example, the aforementioned embodiment describes the case where the differential MOS transistors M1 and M2 are provided in parallel to the differential bipolar transistors Q1 and Q2 as a limiter that amplifies a transmitted signal. Instead of the differential MOS transistors M1 and M2, a pair of resistive elements can also be provided in parallel to the collectors-emitters of the differential bipolar transistors Q1 and Q2. Moreover, instead of the differential bipolar transistors Q1 and Q2, a pair of resistive elements can also be provided in parallel to the channels of the differential MOS transistors M1 and M2. In short, even when one of the differential MOS transistors is turned off, any means can be accepted as long as a current continues to flow into a current combiner or the impedance of the transistor on the off side is reduced.

Moreover, the aforementioned embodiment describes a high frequency module from which a balun is removed. As shown in FIG. 9, the high frequency module may also be constructed as a high frequency module that uses the limiter of the embodiment and connects the balun 14 at the rear stage of the current combiner 12. By adopting such a composition, although miniaturization is difficult, a limiter having an excellent C/N ratio and an excellent harmonic suppression characteristic can be obtained. Furthermore, the aforementioned embodiment describes that the inductors L1 and L2 and the capacitor C1 that construct the current combiner 12 are mounted on or interpolated in a module substrate as an external device of a high frequency IC. The inductors and the capacitor may also be constructed using a pattern in which the current combiner 12 is formed on a high frequency IC chip.

The aforementioned explanation describes the case where an invention made by the inventors applies to a high frequency IC and a high frequency module on which the high frequency IC is mounted and that are used in a radio communication system such as a cellular phone. The system belongs to a field of utilization that forms the background. The present invention is not limited to the high frequency IC or high frequency module, and the present invention can also apply to the high frequency IC and high frequency module for a wireless LAN.

1. A communication semiconductor integrated circuit, comprising:
a limiter that amplifies and outputs a modulated and up-converted transmitted signal, wherein said limiter comprises a pair of differential transistors connected to output pins through open collectors or open drains, and unbalanced reduction means, connected in parallel to said differential transistors, that continues to apply a current to said output pin when one of the transistors enters an off state in accordance with an input signal.

2. A communication semiconductor integrated circuit, comprising:
a limiter that amplifies and outputs a modulated and up-converted transmitted signal, wherein said limiter comprises a pair of differential transistors in which collectors or drain are connected to corresponding output pins respectively, and unbalanced reduction means, connected in parallel to said differential transistors, that reduce impedance of the transistor on an off side when one of the transistors enters an off state in accordance with an input signal.

3. The communication semiconductor integrated circuit according to claim 2, wherein said differential transistors are bipolar transistors, and said unbalanced reduction means are differential MOS transistors connected in parallel to said differential transistors.

4. The communication semiconductor integrated circuit according to claim 2, wherein said differential transistors are bipolar transistors, and said unbalanced reduction means are resistive elements connected in parallel to said differential transistors.

5. The communication semiconductor integrated circuit according to claim 2, wherein said limiter and a gain controllable amplifier circuit that selectively enters an operating state are provided in parallel to said limiter.

6. A communication electronic component, comprising:
a pin in which the communication semiconductor integrated circuit according to claim 2 and a resonance type load circuit connected to said output pin are mounted on or interpolated in an insulating substrate, and that externally outputs a transmitted signal from the insulating substrate as a single phase signal.

7. The communication electronic component according to claim 6, wherein said resonance type load circuit comprises a discrete electronic component mounted on said insulating substrate.

8. The communication electronic component according to claim 6, wherein said resonance type load circuit comprises a conductive pattern formed on a surface or in said insulating substrate.

9. The communication electronic component according to claim 8, wherein said resonance type load circuit comprises a pair of inductance devices connected between said output pin and power voltage pin of said communication integrated circuit and a capacitance device connected between said output pins.

10. A communication semiconductor integrated circuit, comprising:
a limiter that amplifies and outputs a modulated and up-converted transmitted signal, wherein said limiter comprises a pair of differential transistors, a resonance type load circuit connected to collectors or drains of said pair of differential transistors, unbalanced reduction means, connected in parallel to said differential transistors, that reduce impedance of the transistor on an off side when one of the transistors enters an off state according to an input signal, and a pin that is connected to the collector or drain of one of said transistors and outputs a single phase signal as an amplified output signal.

11. The communication semiconductor integrated circuit according to claim 10, wherein said resonance type load circuit comprises a conductive pattern formed on the same chip as a semiconductor chip in which said differential transistors are formed.

12. (canceled)

13. (canceled)

14. (canceled)
